(19) United States
(12) Patent Application Publication
(10) Pub. No.: US 2018/0171120 A1
(43) Pub. Date: Jun. 21, 2018

(54) RUBBER COMPOSITION

(71) Applicant: TOYO TIRE & RUBBER CO., LTD., Itami-shi (JP)

(72) Inventor: Takashi Yuri, Itami-shi (JP)

(73) Assignee: TOYO TIRE & RUBBER CO., LTD., Itami-shi (JP)

(21) Appl. No.: 15/786,066

(22) Filed: Oct. 17, 2017

(30) Foreign Application Priority Data
Dec. 15, 2016 (JP) 2016-243063

(51) Int. Cl. C08L 9/06; B60C 1/00; C08L 7/00; C08K 3/36

(52) U.S. Cl. CPC C08L 9/06; C08K 3/36; C08L 7/00; B60C 1/0016

(57) ABSTRACT

A rubber composition, comprising solution-polymerized polystyrene butadiene rubber in an amount of 10 to 80 parts by mass when the entire amount of rubber components in the composition is regarded as 100 parts by mass; and a thermoplastic elastomer in an amount of 1 to 20 parts by mass for the 100 parts by mass of the rubber components; the thermoplastic elastomer showing a tanδ peak value in the range of −20 to 20° C. in a dynamic viscoelasticity test (temperature dependency measurement at 10 Hz) of the elastomer according to JIS K6394, and the peak value being 1 or more.

### BACKGROUND OF THE INVENTION

### Field of the Invention

The present invention relates to a rubber composition useful as a raw material for producing vulcanized rubbers improved in wet performance, and fatigue resistance and tearing force resistance with a good balance.

### Description of the Related Art

Tires are generally used in various running environments, and are required to be improved in, e.g., wet performance, which is such a performance that the tires grip a wet road surface in rain. However, in the case of making a blend design for a rubber composition to improve the wet performance, the resultant vulcanized rubber maybe deteriorated in fatigue resistance and tearing force resistance. Thus, a technique for improving these properties with a good balance has been required.

Patent Document 1 listed below describes a technique of blending, into a rubber composition for treads, at least one kind of diene elastomer, and a hydrogenated styrene thermoplastic elastomer in an amount of 18 to 40 parts by mass for 100 parts by mass of the diene elastomer to develop a tire tread showing a low rolling resistance and keeping a good wet gripping performance.

Patent Document 2 listed below describes a technique of blending, into a rubber composition, a diene rubber, and an elastomer yielded by hydrogenating a styrene-diene-styrene copolymer partially to provide a rubber composition for tire treads that is improved in steering stability, dry performance and wet performance up to a level higher than a conventional level.

Patent Document 3 listed below describes a technique of blending a hydrogenated styrene based thermoplastic elastomer into a rubber composition to provide a tread rubber composition for high-performance tires that is able to improve the tires in initial gripping performance, gripping performance and durability with a good balance.

Furthermore, Patent Document 4 listed below describes a technique of blending, into a rubber composition, styrene butadiene rubber and a hydrogenated styrene based thermoplastic elastomer to provide a tread rubber composition for high-performance wet tires that is able to improve the tires in initial gripping performance and gripping performance on a wet road surface, and in gripping performance on a dry-up road surface and abrasion resistance.

### PRIOR ART DOCUMENTS

### Patent Documents

Patent Document 1: Japanese Patent No. 5687281

Patent Document 2: JP-A-2014-189698

Patent Document 3: JP-A-2015-110703

Patent Document 4: JP-A-2015-110704

However, the present inventors have made eager investigations to find that when the rubber composition of each of the above-mentioned precedent techniques is made into a vulcanized rubber, there remains, in the techniques, a room to be further improved for an improvement of the vulcanized rubber in wet performance, and fatigue resistance and tearing force resistance with a good balance.

### SUMMARY OF THE INVENTION

In the light of the actual situation, the present invention has been made, and an object thereof is to provide a rubber composition making it possible that when the composition is made into a vulcanized rubber, the rubber is improved in wet performance, and fatigue resistance and tearing force resistance with a good balance.

The object can be attained by the present invention, which relates to a rubber composition including solution-polymerized polystyrene butadiene rubber (referred to also as “S-SBR” hereinafter) in an amount of 10 to 80 parts by mass when the entire amount of rubber components in the composition is regarded as 100 parts by mass, and including a thermoplastic elastomer in an amount of 1 to 20 parts by mass for the 100 parts by mass of the rubber components. This thermoplastic elastomer shows a tanδ peak value in the range of −20 to 20° C. in a dynamic viscoelasticity test (temperature dependency measurement at 10 Hz) of the elastomer according to JIS K6394, and the peak value is 1 or more. In the rubber composition according to the present invention, the specified amount of the rubber components is constituted by the S-SBR, and further the composition includes the thermoplastic elastomer, which shows a tanδ peak in the specified temperature range; thus, a vulcanized rubber obtained from the composition can be improved in wet property. Furthermore, in the vulcanized rubber, the thermoplastic elastomer forms a phase containing no filler such as carbon black or silica (filler absent phase) so that the vulcanized rubber is relieved in stress concentration so as to be improved in fatigue resistance and tearing force resistance. Consequently, the vulcanized rubber is improved in fatigue resistance and tearing force resistance.

The rubber composition preferably further includes, as one or more of the rubber components, at least one selected from the group consisting of emulsion-polymerized polystyrene butadiene rubber (referred to also as “E-SBR” hereinafter), natural rubber (referred to also as “NR” hereinafter), and polybutadiene rubber (referred to also as “BR” hereinafter). When the rubber composition includes, as one or more of the rubber components, at least one of E-SBR, NR and BR besides the S-SBR, the vulcanized rubber can be favorably improved in wet performance, and fatigue resistance and tearing force resistance with a better balance.

The rubber composition preferably further includes a tackifying resin having a softening point of 90 to 160° C. and a number-average molecular weight of 500 to 3000 in an amount of 1 to 40 parts by mass for the entire amount of the rubber components, the entire amount being regarded as the 100 parts by mass. This embodiment makes a further improvement of the vulcanized rubber in wet performance.

### DETAILED DESCRIPTION OF THE PREFERRED EMBODIMENTS

The rubber composition according to the present invention includes, as one of its rubber components, S-SBR in an amount in a specified range, and further includes a specified thermoplastic elastomer. When the entire amount of the rubber components is regarded as 100 parts by mass, the content of the S-SBR is from 10 to 80 parts by mass, preferably from 20 to 70 parts by mass.

The rubber composition according to the present invention may further include, as one of the rubber components, a rubber component other than the S-SBR. When the rubber composition includes, particularly, at least one selected from the group consisting of E-SBR, NR and BR, the resultant vulcanized rubber can be favorably improved in wet performance, and fatigue resistance and tearing force resistance with a better balance. Examples of a diene rubber that is other than E-SBR, NR and BR and that may be included in the rubber composition include polyisoprene rubber (IR), chloroprene rubber (CR), and nitrile rubber (NBR). It is preferred to use, as necessary, a rubber yielded by modifying a terminal of the molecule of a rubber as described above (for example, terminal-modified SBR), or a rubber yielded by modifying a rubber as described above to give a desired property to the rubber (for example, modified NR).

The rubber composition according to the present invention includes the specified thermoplastic elastomer in an amount from 1 to 20 parts by mass, preferably from 3 to 15 parts by mass for the entire amount of the rubber components when this entire amount is regarded as 100 parts by mass. This thermoplastic elastomer is specifically a thermoplastic elastomer showing a tanδ peak value in the range of −20 to 20° C. in a dynamic viscoelasticity test (temperature dependency measurement at 10 Hz) of the elastomer according to JIS K6394, the peak value being 1 or more. The thermoplastic elastomer is in particular preferably a styrene based thermoplastic elastomer.

In the case of using, as the thermoplastic elastomer, a thermoplastic elastomer having a functional group that can react with or interact with a filler which may be blended into the rubber composition, the resultant vulcanized rubber is favorably improved in, particularly, fatigue resistance. Examples of the functional group include a hydroxyl group, an amino group, a carboxyl group, maleicanhydride, asilanol group, analkoxysilyl group, an epoxy group, a glycidyl group, polyether, and polysiloxane. A reason why the use produces the advantageous effect would be that silica and/or carbon black, which will be described below as examples of the filler, has/have many functional groups such as hydroxyl, carboxyl, and silanol groups, so that the functional groups react with or interact with functional groups which the thermoplastic elastomer has, thereby improving the filler in dispersibility in the composition.

The rubber composition according to the present invention may further include a tackifying resin having a softening point of 90 to 160° C. and a number-average molecular weight of 500 to 3000 in an amount preferably from 1 to 40 parts by mass, more preferably from 1 to 25 parts by mass for the entire amount of the rubber components when this entire amount is regarded as 100 parts by mass.

The rubber composition according to the present invention preferably includes silica as a filler. The species of the silica may be a species usable for ordinary rubber-reinforcement, such as wet silica, dry silica, sol-gel silica or surface-treated silica. Out of these species, wet silica is preferred. The blend amount of the silica is preferably from 20 to 120 parts by mass, more preferably from 40 to 100 parts by mass for the entire amount of the rubber components when the entire amount is regarded as 100 parts by mass.

The rubber composition of the present invention may include a silane coupling agent. The silane coupling agent is not particularly limited as far as the agent is a silane coupling agent containing, in the molecule thereof, sulfur. In the rubber composition, various silane coupling agents are usable which are each blended together with silica. Examples thereof include sulfide silanes such as bis(3-triethoxysilylpropyl) tetrasulfide (for example, “Si69” manufactured by Degussa AG), bis(3-triethoxysilylpropyl) disulfide (for example, “Si75” manufactured by Degussa AG), bis(2-triethoxysilylethyl) tetrasulfide, bis(4-triethoxysilylbutyl) disulfide, bis(3-trimethoxysilylpropyl) tetrasulfide, and bis(2-trimethoxysilylethyl)disulfide; mercaptosilanes such as γ-mercaptopropyltrimethoxysilane, γ-mercaptopropyltriethoxysilane, mercaptopropylmethyldimethoxysilane, mercaptopropyldimethylmethoxysilane, and mercaptoethyltriethoxylsilane; and protected mercaptosilanes such as 3-octanoylthio-1-propyltriethoxysilane, and 3-propionylthiopropyltrimethoxysilane. The blend amount of the silane coupling agent is preferably from 1 to 20 parts by mass, more preferably from 1 to 10 parts by mass for 100 parts by mass of the silica.

The rubber composition may contain carbon black as the filler. The species of the carbon black may be any carbon black species used in an ordinary rubber industry, such as SAF, ISAF, HAF, FEF or GPF, or may be an electroconductive carbon black species such as acetylene black or ketjen black. The carbon black is blended into the rubber composition according to the present invention in an amount preferably from 1 to 80 parts by mass, more preferably from 5 to 60 parts by mass for 100 parts by mass of the diene rubbers.

In addition to the diene rubbers, specified thermoplastic elastomer, tackifying resin, carbon black, silica and silane coupling agent each detailed above, the following maybe blended into the rubber composition according to the present invention: vulcanization blending agents, an antiaging agent, zinc oxide, stearic acid, softeners such as wax and oil, a processing aid, and others.

The antiaging agent may be an antiaging agent used ordinarily for rubbers, examples thereof including aromatic amine type, amine-ketone type, monophenolic type, bisphenolic type, polyphenolic type, dithiocarbamate type, and thiourea type antiaging agents. Such antiaging agents may be used singly or in the form of an appropriate mixture of two or more thereof. The antiaging agent content is preferably from 0.5 to 10 parts by mass for 100 parts by mass of the rubber components.

Examples of the vulcanization blending agents include vulcanizing agents such as sulfur and organic peroxides, a vulcanization accelerator, a vulcanization accelerator aid, and a vulcanization retardant.

The species of sulfur as one of the vulcanization blending agents maybe any ordinary sulfur species for rubbers. Examples thereof include powdery sulfur, precipitated sulfur, insoluble sulfur, and highly dispersible sulfur. When physical properties, the durability and others of the resultant vulcanized rubber are considered, the blend amount of the sulfur is preferably from 0.1 to 10 parts by mass for 100 parts by mass of the rubber components, the amount being in terms of the sulfur content.

The vulcanization accelerator may be a vulcanization accelerator used ordinarily for rubber-vulcanization. Examples thereof include sulfenamide type, thiuram type, thiazole type, thiourea type, guanidine type, and dithiocarbamate type vulcanization accelerators. Such vulcanization accelerators may be used singly or in the form of an appropriate mixture of two or more thereof. The blend amount of the vulcanization accelerator(s) is preferably from 0.1 to 10 parts by mass for 100 parts by mass of the rubber components.

The rubber composition according to the present invention can be yielded by using a kneading machine used in an ordinary rubber industry, such as a Banbury mixer, a kneader or a roll, to mix/knead the diene rubbers, specified thermoplastic elastomer, tackifying resin, carbon black, silica and silane coupling agent each detailed above, and components that maybe optionally used, which are carbon black, vulcanization blending agents, an antiaging agent, zinc oxide, stearic acid, softeners such as wax and oil, a processing aid and others.

The method for blending each component with each other is not particularly limited, and may be, for example, a method of mixing/kneading, in advance, blending components other than the vulcanization blending agents such as the sulfur-containing vulcanizing agent and the vulcanization accelerator to prepare a masterbatch, adding the remaining components thereto, and further mixing/kneading the entire components; a method of adding each individual component in any order, and then mixing/kneading the components; or a method of adding the entire components simultaneously and mixing/kneading the components.

### EXAMPLES

Hereinafter, a description will be made about examples demonstrating the subject matter and the advantageous effects of the present invention specifically, and others. In evaluating-items in the examples, and comparative examples, evaluations were made on the basis of evaluation conditions described below about rubber samples each yielded by heating and vulcanizing each rubber composition at 150° C. for 30 minutes.

### (1) Wet Performance (Wet Gripping Performance)

A viscoelasticity tester manufactured by Toyo Seiki Seisaku-sho, Ltd. is used to measure the loss tangent tanδ of one of the samples of each of the above-mentioned examples at a frequency of 10 Hz, a static strain of 10%, a dynamic strain of 1% and a temperature of 0° C. About each of the examples, the measured value is represented as an index relative to the value of Comparative Example 1, this value being regarded as 100. It is meant that as the resultant numerical value is larger, the rubber composition is better in wet performance.

### (2) Tearing Force Resistance

A crescent shaped member prescribed in JIS K6252 is used to punch out one of the samples. In the center of a dent in the punched-out sample, a notch of 0.50±0.08 mm in size is made. A test of the resultant is made through a tensile tester manufactured by Shimadzu Corporation at a tension rate of 500 mm/min. About each of the examples, the measured value is represented as an index relative to the value of Comparative Example 1, this value being regarded as 100. It is meant that as the resultant numerical value is larger, the rubber composition is better in tearing force resistance.

### (3) Fatigue Resistance (Bending Fatigue Resistance)

In accordance with JIS K6260, a measurement of one of the samples is made at a temperature of 23° C. The sample is bent until the resultant crack grows to reach into a size of 2 mm. The number of times of the bending to reach the size is gained. About each of the examples, the measured value is represented as an index relative to the value of Comparative Example 1, this value being regarded as 100. It is meant that as the resultant numerical value is larger, the rubber composition is better in fatigue resistance.

### (Preparation of Each Rubber Composition)

In a blend formulation in one of Tables 1 and 2, a rubber composition of each of Examples 1 to 13 and Comparative Examples 1 to 5 was formulated, and then kneaded by using an ordinary Banbury mixer to prepare a rubber composition. The blending agents shown in Tables 1 and 2 are as follows (in each of Tables 1 and 2, the blend amount of each of the blending agents is represented as a numerical value (in the unit of parts by mass) that is relative to 100 parts by mass of rubber components).
a) Thermoplastic Elastomers:

Thermoplastic elastomer 1: “S.O.E. S1605” manufactured by Asahi Kasei Corporation, (styrene-(hydrogenated SB)-styrene block copolymer; tanδ peak value=1.38, and peak temperature=18° C.)

Thermoplastic elastomer 2: “HYBRAR 7125” manufactured by Kuraray Co., Ltd., (styrene-(hydrogenated IP)-styrene block copolymer; tanδ peak value=1.84, and peak temperature=−6° C.)

Thermoplastic elastomer 3: “S.O.E. S1611” manufactured by Asahi Kasei Corporation, (styrene-(hydrogenated SB)-styrene block copolymer; tanδ peak value=0.83, and peak temperature=9° C.)

Thermoplastic elastomer 4: “Tuftec H1062” manufactured by Asahi Kasei Corporation, (hydrogenated SEBS; tanδ peak value=0.86, and peak temperature=−47° C.)

Thermoplastic elastomer 5 (modified thermoplastic elastomer): Into a pressure-resistant vessel equipped with a stirrer were added 800 g of cyclohexane, 38 g of sufficiently dehydrated styrene, and 7.7 g of a sec-butyl lithium solution (10% by weight) in cyclohexane to conduct polymerization reaction at 50° C. for 1 hour. Next, thereto was added 127 g of a mixture of styrene and butadiene (molar ratio of styrene:butadiene=3:4) to conduct polymerization reaction for 1 hour. Thereafter, thereto was further added 38 g of styrene to conduct polymerization reaction for 1 hour. Thereafter, thereto was added 2.5 g of chlorotriethoxysilane. Finally, thereto was added methanol to stop the reaction to synthesize a styrene-(styrene/butadiene)-styrene type block copolymer having, at a single terminal of the molecule thereof, an ethoxysilyl group. The reaction solution was distilled under reduced pressure to remove the solvent to produce a thermoplastic elastomer 5. The number-average molecular weight thereof was 163,000, which was analyzed through a GPC (gel permeation chromatograph), and the styrene content therein was 60%. The tanδ peak value thereof was 1.23, and the peak temperature was 7° C. The used GPC was a GPC “HPC-8020” manufactured by Tosoh Corporation, and tetrahydrofuran was used as a solvent. The measurement of the molecular weight was made in terms of a standard polystyrene.
b) Rubber Components:

S-SBR: “VSL 5025-0HM”, manufactured by Lanxess AG

E-SBR: “SBR 1502”, manufactured by JSR Corporation

NR: “RSS #3”

BR: “BR 150B”, manufactured by Ube Industries, Ltd.
c) “NIPSIL AQ” manufactured by Tosoh Silica Corporation
d) Carbon black: “DIABLACK N341” manufactured by Mitsubishi Chemical Corporation
e) Silane coupling agent: “Si 69” manufactured by Evonik Degussa GmbH
f) Oil: “PROCESSNC140”, manufactured by Japan Energy Corporation
g) Tackifying Resins:

Tackifying Resin 1: “FTR 6125” manufactured by Mitsui Chemicals, Inc., (copolymer made from a styrene based monomer and an aliphatic monomer; softening point: 125° C., and molecular weight: 1950)

Tackifying Resin 2: “FMR 0150” manufactured by Mitsui Chemicals, Inc., (copolymer made from a styrene based monomer and indene; softening point: 145° C., and molecular weight: 1190)

Tackifying Resin3: “NITTORESING90” manufactured by Nitto Chemical Co., Ltd., (coumarone resin; softening point: 90° C., and molecular weight: 770)
h) Zinc flower: “Zinc flower No. 1” manufactured by Mitsui Mining & Smelting Co., Ltd.
i) Antiaging agent: “ANTIGEN 6C” manufactured by Sumitomo Chemical Co., Ltd.
j) Stearic acid: “LUNAC S-20” manufactured by Kao Corporation
k) Wax: “OZOACE 0355” manufactured by Nippon Seiro Co., Ltd.
l) Sulfur: “5%-Oil-blended powdery sulfur” manufactured by Tsurumi Chemical Industry Co., Ltd.
m) Vulcanization Accelerators:

Vulcanization accelerator 1: “SOXINOL CZ” manufactured by Sumitomo Chemical Co., Ltd.

Vulcanization accelerator 2: “NOCCELER D”, manufactured by Ouchi Shinko Chemical Industrial Co., Ltd.

TABLE 1

| | Comparative | Comparative | Comparative | Comparative | Comparative | Comparative |
|---|---|---|---|---|---|---|
| | Example 1 | Example 2 | Example 3 | Example 3 | Example 4 | Example 5 |
| Thermoplastic | | | 10 | | | 30 |
| elastomer 1 | | | | | | |
| Thermoplastic | | | | 10 | | |
| elastomer 3 | | | | | | |
| Thermoplastic | | | | | 10 | |
| elastomer 4 | | | | | | |
| S-SBR | 70 | 70 | | 70 | 70 | 70 |
| E-SBR | | | 70 | | | |
| NR | | | | | | |
| BR | 30 | 30 | 30 | 30 | 30 | 30 |
| Silica | 70 | 70 | 70 | 70 | 70 | 70 |
| Coupling agent | 7 | 7 | 7 | 7 | 7 | 7 |
| Carbon black | 10 | 10 | 10 | 10 | 10 | 10 |
| Silane coupling agent | 7 | 7 | 7 | 7 | 7 | 7 |
| Oil | 20 | 10 | 20 | 20 | 20 | 20 |
| Tackifying resin 1 | | 10 | | | | |
| Tackifying resin 2 | | | | | | |
| Tackifying resin 3 | | | | | | |
| Zinc flower | 3.0 | 3.0 | 3.0 | 3.0 | 3.0 | 3.0 |
| Antiaging agent | 2.0 | 2.0 | 2.0 | 2.0 | 2.0 | 2.0 |
| Stearic acid | 2.0 | 2.0 | 2.0 | 2.0 | 2.0 | 2.0 |
| Wax | 2.0 | 2.0 | 2.0 | 2.0 | 2.0 | 2.0 |
| Sulfur | 1.5 | 1.5 | 1.5 | 1.5 | 1.5 | 1.5 |
| Vulcanization | 1.8 | 1.8 | 1.8 | 1.8 | 1.8 | 1.8 |
| accelerator 1 | | | | | | |
| Vulcanization | 2.0 | 2.0 | 2.0 | 2.0 | 2.0 | 2.0 |
| accelerator 2 | | | | | | |
| Wet gripping | 100 | 108 | 106 | 102 | 98 | 130 |
| performance | | | | | | |
| Tearing force | 100 | 106 | 110 | 110 | 108 | 94 |
| resistance | | | | | | |
| Bending fatigue | 100 | 98 | 110 | 108 | 106 | 108 |
| resistance | | | | | | |

TABLE 2

| | Exam- | Exam- | Exam- | Exam- | Exam- | Exam- | Exam- | Exam- | Exam- | Exam- | Exam- | Exam- | Exam- |
|---|---|---|---|---|---|---|---|---|---|---|---|---|---|
| | ple 1 | ple 2 | ple 3 | ple 4 | ple 5 | ple 6 | ple 7 | ple 8 | ple 9 | ple 10 | ple 11 | ple 12 | ple 13 |
| Thermoplastic | 5 | 10 | | | | | | | | | | 10 | 10 |
| elastomer 1 | | | | | | | | | | | | | |
| Thermoplastic | | | 10 | | 10 | 10 | 10 | 10 | 10 | 10 | 10 | | |
| elastomer 2 | | | | | | | | | | | | | |
| Thermoplastic | | | | 10 | | | | | | | | | |
| elastomer 5 | | | | | | | | | | | | | |
| S-SBR | 70 | 70 | 70 | 70 | 50 | 50 | 70 | 70 | 70 | 70 | 70 | | 70 |
| E-SBR | | | | | 20 | 20 | | | | | | | |
| NR | | | | | | 15 | 15 | | | | | | |
| BR | 30 | 30 | 30 | 30 | 30 | 15 | 15 | 30 | 30 | 30 | 30 | 30 | 30 |
| Silica | 70 | 70 | 70 | 70 | 70 | 70 | 70 | 70 | 70 | 70 | 70 | 70 | 40 |
| Coupling agent | 7 | 7 | 7 | 7 | 7 | 7 | 7 | 7 | 7 | 7 | 7 | 7 | 7 |
| Carbon black | 10 | 10 | 10 | 10 | 10 | 10 | 10 | 10 | 10 | 10 | 10 | 10 | 40 |
| Silane coupling agent | 7 | 7 | 7 | 7 | 7 | 7 | 7 | 7 | 7 | 7 | 7 | 7 | 4 |
| Oil | 20 | 20 | 20 | 20 | 20 | 20 | 20 | 10 | 10 | 10 | | 20 | 10 |
| Tackifying resin 1 | | | | | | | | 10 | | | 30 | | |
| Tackifying resin 2 | | | | | | | | | 10 | | | | |
| Tackifying resin 3 | | | | | | | | | | 10 | | | |
| Zinc flower | 3.0 | 3.0 | 3.0 | 3.0 | 3.0 | 3.0 | 3.0 | 3.0 | 3.0 | 3.0 | 3.0 | 3.0 | 3.0 |
| Antiaging agent | 2.0 | 2.0 | 2.0 | 2.0 | 2.0 | 2.0 | 2.0 | 2.0 | 2.0 | 2.0 | 2.0 | 2.0 | 2.0 |
| Stearic acid | 2.0 | 2.0 | 2.0 | 2.0 | 2.0 | 2.0 | 2.0 | 2.0 | 2.0 | 2.0 | 2.0 | 2.0 | 2.0 |
| Wax | 2.0 | 2.0 | 2.0 | 2.0 | 2.0 | 2.0 | 2.0 | 2.0 | 2.0 | 2.0 | 2.0 | 2.0 | 2.0 |
| Sulfur | 1.5 | 1.5 | 1.5 | 1.5 | 1.5 | 1.5 | 1.5 | 1.5 | 1.5 | 1.5 | 1.5 | 1.5 | 1.5 |
| Vulcanization | 1.8 | 1.8 | 1.8 | 1.8 | 1.8 | 1.8 | 1.8 | 1.8 | 1.8 | 1.8 | 1.8 | 1.8 | 1.8 |
| accelerator 1 | | | | | | | | | | | | | |
| Vulcanization | 2.0 | 2.0 | 2.0 | 2.0 | 2.0 | 2.0 | 2.0 | 2.0 | 2.0 | 2.0 | 2.0 | 2.0 | 2.0 |
| accelerator 2 | | | | | | | | | | | | | |
| Wet gripping | 108 | 120 | 122 | 122 | 114 | 116 | 124 | 130 | 132 | 127 | 146 | 114 | 108 |
| performance | | | | | | | | | | | | | |
| Tearing force | 108 | 112 | 110 | 113 | 114 | 120 | 122 | 115 | 114 | 116 | 110 | 110 | 116 |
| resistance | | | | | | | | | | | | | |
| Bending fatigue | 110 | 118 | 124 | 128 | 128 | 123 | 122 | 123 | 120 | 124 | 126 | 120 | 114 |
| resistance | | | | | | | | | | | | | |

From the results in Tables 1 and 2, it is understood that the vulcanized rubber of the rubber composition of each of Examples 1 to 13 is improved in wet performance, fatigue resistance and tearing force resistance with a good balance.

What is claimed is:

1. A rubber composition, comprising solution-polymerized polystyrene butadiene rubber in an amount of 10 to 80 parts by mass when the entire amount of rubber components in the composition is regarded as 100 parts by mass; and a thermoplastic elastomer in an amount of 1 to 20 parts by mass for the 100 parts by mass of the rubber components; the thermoplastic elastomer showing a tanδ peak value in the range of −20 to 20° C. in a dynamic viscoelasticity test (temperature dependency measurement at 10 Hz) of the elastomer according to JIS K6394, and the peak value being 1 or more.

2. The rubber composition according to claim 1, further comprising, as one or more of the rubber components, at least one selected from the group consisting of emulsion-polymerized polystyrene butadiene rubber, natural rubber, and polybutadiene rubber.

3. The rubber composition according to claim 1, further comprising a filler, and the thermoplastic elastomer being a thermoplastic elastomer having a functional group that can react with or interact with the filler.

4. The rubber composition according to claim 1, further comprising a tackifying resin having a softening point of 90 to 160° C. and a number-average molecular weight of 500 to 3000 in an amount of 1 to 40 parts by mass for the entire amount of the rubber components, the entire amount being regarded as the 100 parts by mass.
